(19) United States
(12) Patent Application Publication
(10) Pub. No.: US 2006/0038535 A1
(43) Pub. Date: Feb. 23, 2006

(54) Handy man's power pack / back pack / outlet on the go

(76) Inventor: William Francis Lang, Lutz, FL (US)

Correspondence Address: William Francis Lang, 4611 Kilcoyne Ct., Lutz, FL, 33558, US

(21) Appl. No.: 10/923,768

(22) Filed: Aug. 23, 2004

(51) Int. Cl. H02J 7/00

(52) U.S. Cl. 320/112

(57) ABSTRACT

In abstract form, The Handy Man's Power Pack/Back Pack/Outlet on the Go, utilizes a light weight padded back pack with a power inverter attached to it with a rechargeable battery inside the back pack for purposes of operating low amperage, tools and appliances without the use of generators that utilize fuel and require lengthy extension cords.

### BACKGROUND OF THE INVENTION

Field of the Invention

The Handy Man's Power Pack/Back Pack/Outlet on the Go, was made to aid the typical man/woman by providing a wireless source of power, that is rechargeable and compact enough to go anywhere, by use of a light weight back pack that can be used for:

1. For any type of power equipment that requires less than 7.2 amps (lawn and gardening equipment such as an Edger, Blowers, Hedger and Weed Whacker.)

2. For camping lighting, televisions, toasters, radios, electric grills etc.

3. For remote areas where power is not supplied such as vacant land or near bodies of waters such as the edge of a pond, lake or stream where extension cords can be very dangerous.

4. For any electric tool or appliance that draws less than 7.2 amps.

5. Provides a remote power source that also harnesses the ability to jump start a vehicle.

### BRIEF SUMMARY OF THE INVENTION

The idea in general is to provide a back pack power source that is rechargeable, light weight and powerful enough to supply an electrical power source to any location be it urban, suburban or rural without the use of long cumbersome extension cords (requires a 3 ft. cord for almost any application) or very heavy generators that require gasoline or other types of fuels. The back pack is also nature friendly with it's power source being recyclable.

### BRIEF DESCRIPTION OF SEVERAL VIEWS OF THE DRAWING

FIG. 1. Illustrates the attachment of the power inverter to the back pack.

FIG. 1. Also Illustrates how the power cables that are attached to the inverter also extend into the back pack where the battery is kept.

FIG. 2. Illustrates the power receptacles at the bottom of the inverter that is attached to the back pack by ¼ inch aluminum brads.

FIG. 3. Illustrates the top view of the power pack unzipped with the power cables attached to the battery inside the power pack.

FIG. 4. Illustrates the back side of the back pack and the padded shoulder straps.

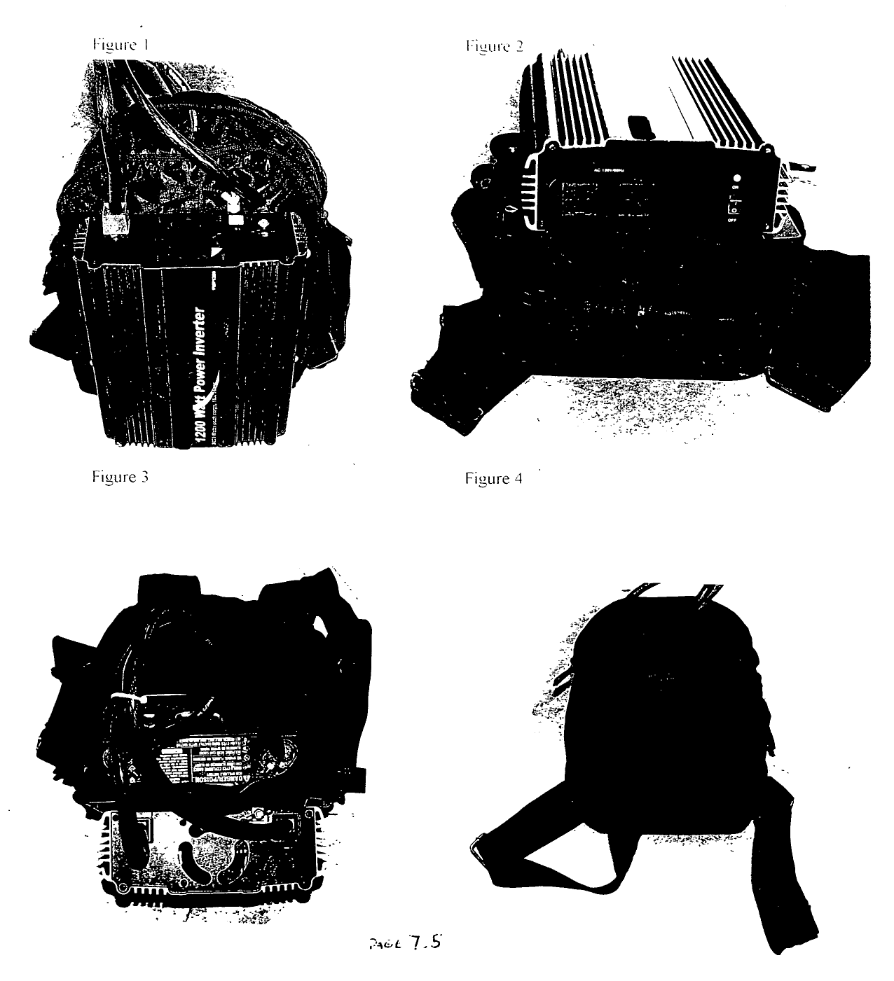

### DETAILED DESCRIPTION OF THE INVENTION

The Handy Man's Back Pack/Power Pack/Outlet on the Go, is a light weight neoprene back pack that has a padded back and padded straps for increased comfort. The bottom of the pack is also padded, double layered/stitched for comfort and for the required strength to hold the appropriate battery size and weight.

The back pack has 4—⅜ inch stainless steel eyelets on the front of it that are used to hold the power inverter in place with ¼ inch aluminum brads.

On the top section of the pack there are 2—¾ inch stainless steel eyelets positioned to receive the ½ inch cables that supply the power to the inverter via the battery terminals that are held in place by a 2 inch/¼ inch bolt and wing nut through the batteries terminal eyelets.

The back pack kit also contains a 12 volt charger that has the auto shutoff feature when the battery is fully charged.

A 36 inch/10 gauge cord is all that is required to plug into the inverter to operate any electrical device that requires less than 7.2 amps of power to operate. (Heavy duty models that can handle greater amperages are available).

Once the pack is assembled and the cord has been plugged in all that is needed is to plug your favorite piece of equipment in and turn inverter switch on and your ready to go to work.

To recharge the back pack after using simply place the red (positive) clamp on the positive side of the battery and the black (negative) clamp on the negative side of the battery and turn the charger on until the green light is on which verifies that the battery is fully charged.

The light weight padded design of the back pack make the Handy Man's Power Pack/Back Pack/Outlet on the Go, a safe and convenient way to operate tools, small appliances and yard equipment anywhere at any time without the use of bulky generators that require fuel to operate and long cumbersome extension cords.

1. What I claim as my invention, is the Handy Man'S Power Pack/Back Pack/Outlet on the Go. This light weight back pack with a power inverter attached to it, has a rechargeable battery as an affordable source of transportable power, that is by it's unique design, a back pack that can go anywhere and be used in any situation that you might need a power source that draws 7.2 amps or less.
This design can be used for electric lawn and gardening equipment, camping applications, operating various electric tools, small appliances and in emergency situations where power has been cut off or where a power supply is needed. The short cord required to operate the desired tool of choice, even makes it safe to use around bodies of water such as lakes ponds or swimming pools.
